(19) United States
(12) Patent Application Publication
(10) Pub. No.: US 2008/0114753 A1
(43) Pub. Date: May 15, 2008

(54) Method and a device for ranking linked documents

(75) Inventor: Hillel Tal-Ezer, Natania (IL)

Correspondence Address: Martin D. Moynihan;PRTSI, Inc., P.O. Box 16446, Arlington, VA, 22215, US

(73) Assignee: Apmath Ltd., Herzlia Pituach (IL)

(21) Appl. No.: 11/826,907

(22) Filed: Jul. 19, 2007

Related U.S. Application Data
(60) Provisional application No. 60/858,947, filed on Nov. 15, 2006.

(51) Int. Cl. G06F 17/30

(52) U.S. Cl. 707/5; 707/E17.001

(57) ABSTRACT

A method of determining a ranking for a number of linked documents. The method comprises the following steps: a) analyzing the documents for documenting links to and from each of the documents, b) virtually adding a link to each of the documents from a virtual document, c) virtually adding a link to the virtual document from each of the plurality of documents, and d) assigning rankings to each of the plurality of documents based on the links and the virtual links.

### RELATED APPLICATIONS

This application claims the benefit of U.S. Provisional Patent Application No. 60/858,947 filed on Nov. 15, 2006, the contents of which are incorporated herein by reference.

The teachings of U.S. Provisional Patent Application No. 60/810,692 filed on Jun. 5, 2006, are also incorporated herein by reference.

### FIELD AND BACKGROUND OF THE INVENTION

The present invention relates to techniques for analyzing linked databases and, more particularly but not exclusively, to assigning ranks to nodes in a linked database, such as any database of documents containing citations, the World Wide Web or any other hypermedia database.

The computer networks accessible today, including the World Wide Web (the “Web”) allow access to an enormous amount of information that increases daily. This growth, combined with the highly decentralized nature of the Web, creates a substantial difficulty in locating selected information content. Web search services generally perform an incremental scan of the Web to generate various, often substantial indexes that can later be searched in response to a user's query. The generated indexes are essentially databases of document identification information. Search engines use these indexes to provide generalized content based searching but a difficulty occurs in trying to evaluate the relative merit or relevance of identified documents. Thus, a user's time can be inefficiently spent on viewing numerous documents that are not relevant to what he is looking for.

Search engines presently use various techniques that attempt to present documents that are more relevant to a user's query. Typically, documents are ranked according to variations of a standard vector space model. These variations may include how recently the document was updated, how close the search terms are to the beginning of the document, etc. However, the most commonly used search engines are hyperlink search engines that use information from pages that contain links to assist in identifying and assessing relevant Web documents. Rather than using the content of a document to determine its relevance, the technique uses links to the document to characterize the relevance of a document. In particular, a rank is assigned to a document based on the number of documents that are linked thereto. The well-known idea of citation counting is a simple method for determining the importance of a document by counting the number of related citations, or backlinks. The citation rank r(A) of a document which has n related citations is simply r(A)=n. Many databases, however, have extreme variations in the quality and importance of documents. In these cases, citation ranking is overly simplistic. For example, citation ranking will give the same rank to a document that is cited once on an obscure page as to a similar document that is cited once on a well-known and highly respected page.

Few methods and systems have been developed in order to improve the ranking process. For example, U.S. Pat. No. 6,285,999, published Sep. 4, 2001, and “The PageRank Citation Ranking: Bringing Order to the Web” of L. Page, S. Brin et al., published in 1998 in the Stanford Digital Libraries as Working Paper No. SIDL-WP-1999-0120, describe a method that assigns ranks to nodes in a linked database, such as any database of documents containing citations, the Web or any other hypermedia database. The rank assigned to a document is calculated from the ranks of documents that cite it. In addition, the rank of a document is calculated from a constant representing the estimated probability that a browsing user will randomly view another document in the database. This method is used in commercial search engines such as the Google™ search engine.

Improvements to this citation ranking method have been developed in recent years. For example, U.S. Pat. No. 6,799,176, published Sep. 28, 2004, discloses a method for ranking documents stored in a network that includes identifying links from linking documents to linked documents in the network and determining the importance of the identified links. The method further includes weighting the identified links based on the determined importance and ranking the linked documents, based on the weighted links.

However, the aforementioned improvements do not overcome all the disadvantages of the known citation ranking methods. A known problem of processing the ranking of documents using the known citation ranking methods, is a rank-sink problem. Consider two Webpages that are linked to each other but are not linked to other Webpages, creating a hyperlinked loop. Suppose there are some Webpages that point to one of the loop's members. Then, as there is no forward link which points to a Webpage external to the loop, during the process the Webpages within the loop will have increasing ranks but will not cause an increase in rank to Webpages outside of the loop. The loop forms a sort of trap that is known as a rank-sink. Though some known methods integrate mechanisms that reduce the effect of rank-sinks, there is still a need for a ranking method that can rank documents and Webpages without being affected by rank-sinks. One of the difficulties associated with reducing the effect of rank-sinks is that there is no control over the World Wide Web or other collections of documents. The search engine has to reflect the links present in real life and real life includes sinks.

There is thus a widely recognized need for, and it would be highly advantageous to have, a method and a device for performing ranking based upon citations, which is devoid of the above limitations.

### SUMMARY OF THE INVENTION

According to one aspect of the present invention there is provided a method of determining rankings among a number of documents. The method comprises the following steps: a) analyzing the number of documents for documenting links to and from each of the number of documents, b) virtually adding a link to each of the number of documents from a virtual document, c) virtually adding a link to the virtual document from each of the number of documents, and d) assigning rankings to each of the number of documents based on the links and the virtual links.

Preferably, a subtraction of one link from one of the number of documents does not substantially change the ranking.

Preferably, an addition of one link to one of the number of documents does not substantially change the ranking.

Preferably, the assigning comprises scoring each of the number of documents based on the links and the virtual links and using the scores for ranking the number of documents.

More preferably, the scoring a certain document is determined according to scores of at least one document of the number of documents linking to the certain document and of the virtual document.

Preferably, the ranking is determined according to a uniform resource locator (URL), a host, a domain, an author, an institution, or a last update time of the at least one linked document.

Preferably, the adding of stage b) comprises adding weights to respective links to each one of the documents from the virtual document, the assigning rankings of stage d) to each one of the documents is based on the weights.

More preferably, the weight is based on the probability that a surfing user will browse a respective document of the documents.

Preferably, for each of the number of documents the ranking is determined according importance, visibility or textual emphasis of the documents linking to it.

Preferably, the number of documents belonging to a group consisting of: the Web, the Ethernet, a wired or wireless computer network, and a local area network.

Preferably, each one of the number of documents is a member of a group consisting of: Web pages, files, WORD documents, PDF documents, XML pages, HTML pages, and Internet page.

Preferably, the method further comprises identifying a weighting factor for each of the linking documents and adjusting the ranking based on the weighting factor.

More preferably, the weighting factor is dependent on the number of the number of documents.

Preferably, each one of the number of documents represents a member of a group of linked entities.

More preferably, the group of linked entities is a member of a group consisting of: a market of buyers and sellers, a group of peer-to-peer network users, and a group of e-commerce environment members.

According to another aspect of the present invention there is provided a device for managing rankings for a number of linked documents. The device comprises a mapping module, configured for mapping a number of documents, at least some of the number of documents are linked documents, the mapping module is further configured to link a virtual document to and from each of the number of documents and a scoring module for assigning a ranking for at least one of the number of documents, the ranking is dependent on rankings of at least one of the linked documents including the virtual document.

Preferably, each one of the rankings is determined according to links to related documents of the at least one of the linking documents.

Preferably, each one of the rankings is determined according to links from related documents of the at least one of the linking documents.

Preferably, the ranking is determined according to a uniform resource locator (URL), a host, a domain, an author, an institution, or a last update time of the linking documents.

Preferably, the ranking is determined according to importance, visibility or textual emphasis of the links in the linking documents.

Preferably, the number of documents comprises a member of a group consisting of: the Web, the Ethernet, a wired or wireless computer network, and a local area network.

Preferably, each one of the number of documents is a member of a group consisting of: a Web page, a file, a WORD document, a PDF document, an XML page, an HTML page, and an Internet page.

Preferably, the assigning further comprises identifying a weighting factor for each of the linking documents and adjusting the ranking based on the weighting factor.

More preferably, the weighting factor is dependent on the number of the number of documents.

According to another aspect of the present invention there is provided a method of ranking documents networked together by links. The method comprises the following steps: adding a virtual document to the documents networked together, adding to each document a virtual link to and from the virtual document, thereby converting the networked links into a strongly connected graph, iteratively providing scores to each of the documents according to a number of links thereto and scores assigned to other documents linked thereto, the number of links including the virtual links, and ranking the documents according to the scores.

According to another aspect of the present invention there is provided a search engine for searching networked documents in a database. The search engine comprises a ranking module configured for mapping the networked documents, at least some of the networked documents are linked documents, the ranking module configured to link a virtual document to and from each of the networked documents, the ranking module configured for assigning a ranking for at least one of the networked documents, the ranking is dependent on rankings of at least one of the linked documents including the virtual document and a searching module configured for searching through the networked documents for hits according to a received query, the searching module is configured for retrieving hits and ordering the hits according to the ranking.

Unless otherwise defined, all technical and scientific terms used herein have the same meaning as commonly understood by one of ordinary skill in the art to which this invention belongs. The materials, methods, and examples provided herein are illustrative only and are not intended to be limiting.

Implementation of the method and device of the present invention involves performing or completing certain selected tasks or steps manually, automatically, or a combination thereof. Moreover, according to actual instrumentation and equipment of preferred embodiments of the method and device of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and device of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a diagram of the relationship between three linked hypertext documents;

FIG. 2 is an exemplary diagram of six hyperlinked documents illustrating the formation of a rank-sink;

FIG. 3 is another exemplary diagram of hyperlinked documents illustrating the formation of a rank-sink and a virtual document that is used to prevent the rank-sink problem, according to a preferred embodiment of present invention;

FIG. 4 is a flowchart of an exemplary method for determining a ranking for a number of linked documents, according to a preferred embodiment of the present invention;

FIG. 5 is an exemplary graph of eight nodes, which is used to exemplify the differences between ranking a group of documents using a known ranking citation method and ranking the same group of documents using the ranking citation method of the present invention; and

FIGS. 6A-6C are exemplary graphs of two groups of nodes, which are used to exemplify the differences between ranking a group of documents using a known ranking citation method and ranking the same group of documents using the ranking citation method of the present invention.

### DESCRIPTION OF THE PREFERRED EMBODIMENTS

The present embodiments comprise an apparatus and a method of scoring a plurality of linked documents. As explained in greater detail below, the embodiments of the present invention are designed to improve known citation ranking processes by overcoming ranking inconsistencies that are caused by a phenomenon that is known as the rank-sink problem. The rank-sink problem occurs only when not all the documents in the group of ranked documents can be represented as one strongly connected graph. Therefore, the embodiments of the invention are designed to ensure that during the ranking process the ranked documents can be represented as a strongly connected graph. In the present embodiments, the score of a particular document may be more consistent with the actual prevalence, importance, and accessibility of backlinks and citations that are related to that document than the score given using other citation ranking processes.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

The present invention is directed towards an apparatus and a method for determining a ranking for a number of linked documents. The method allows ranking that avoids distortions that may be caused by random rank-sinks which are formed in the graph that represent the linked documents. According to a preferred embodiment of the present invention, a method of determining the ranking for a number of linked documents comprises several steps. During the first step, the number of documents is identified. Some of the documents have a link thereto from one or more linking documents. Some of the documents links to one or more other documents.

Then, a virtual document is created and artificially linked to and from each of the analyzed documents. As the virtual document is now connected to each one of the analyzed document, it transforms the network to a strongly connected network in which each document is connected using a chain of links to any other document in the network. Such a strongly connected network is immunized from the formation of rank-sinks within.

Artificial linking, as referred to above comprises creating two links, one to and one from the virtual document to each of the other documents. Thus there is formed a mutual linking relationship between each one of the documents and the virtual document. Then, scores are assigned for to the documents and the documents are ranked according to the scores. The score is dependent on the scores of documents linking to the current document as described below. As further described below, in the embodiment of the present invention the probability that the surfing user randomly views any document instead of following a forward link is reflected from the number of related forward links. The contribution of these random views is represented by an additional forward link that links to the document from the added virtual document. This is different from the known ranking methods in which a probability variable that the surfing user randomly views any document instead of following a forward link is constant and predetermined.

A network entity may be understood as a server, a router, a personal computer, or any other computing unit which can be used for implementing database management.

A communication network may be understood as the Internet, the Ethernet, a wired or wireless computer network, a local area network, etc.

A document may be understood as a Web page, a file, a WORD document, a PDF document, an XML page, an HTML page, an Internet page, or any other document which is accessible via a communication network.

A group of documents may be understood as the World Wide Web, a collection of academic papers, a collection of judicial precedents, a collection of judicial documents, an encyclopedia, a collection of medical publications, etc.

The term “substantially change”, which is used in the present specification, should be interpreted to include, for example, changing the position of a document or node in a ranking vector that from a low position to a high position, from a high position to a low position, or from a first position to a second position which is relatively distant from the first position.

A document identification mark may be understood as a hyperlink, a uniform resource locator (URL) address, a pointer to a document, a logical address of a document in storage, a relative address of a document in storage, or a reference to a document or to another resource.

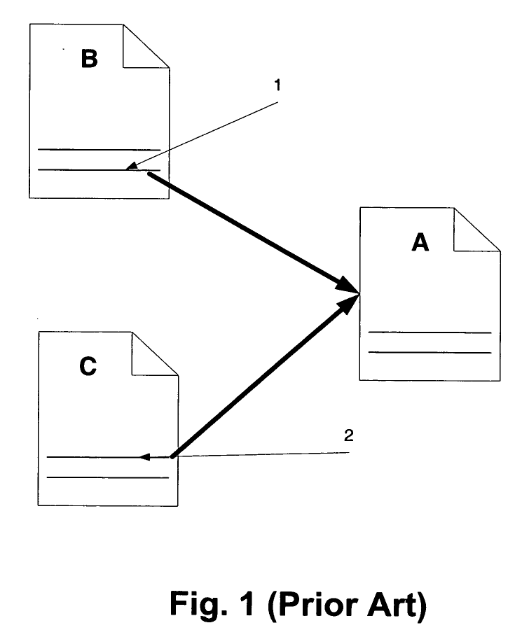

A linked database may be understood as any database of documents containing mutual citations, such as the Web, a dictionary, a hypermedia archive, a thesaurus, a database of academic articles, a database of patents, and a database of court cases. The linked database can be represented as a directed graph of N nodes, where each node corresponds to a document and where the directed connections between nodes correspond to links from one document to another. A given node has a set of forward links that connect it to children nodes, and a set of backward links that connect it to parent nodes. FIG. 1 shows a typical relationship between three hypertext documents A, B, and C. As shown in this particular figure, the links 1 and 2 in documents B and C, respectively, are pointers to document A. In this case, B and C comprise forward links to document A, and links 1 and 2 are backlinks of document A.

The ranking method of the present invention is based on the well-known idea of citation counting. In a simple citation ranking, the rank of a document A which has n backlinking documents is simply:

r(A)=n Function 1

More subtle and complex methods that use citation ranking and give better results are known. For example, U.S. Pat. No. 6,285,999, published Sep. 4, 2001, discloses a citation ranking method in which the backlinks from different documents are weighted differently and the number of links on each document is normalized. More precisely, this patent discloses a method in which the rank of a document Xi is defined approximately as:

$$\begin{matrix}{x}_{i} = ( α ) {\sum }_{j ∈ {L}_{i}} \frac{{X}_{j}}{{n}_{j}} + ( 1 - α ) {\sum }_{j = 1}^{N} \frac{1}{N} {x}_{j} \\ 1 \leq i \leq N & \end{matrix} \qquad Function 2$$

where Xj is the importance of document j, nj is the number of forward links from document j, α is a constant in the interval [0, 1], N is the total number of documents in the Web, and Li is a set of indices of documents linking to document i. This definition is clearly more complicated and subtle than that of the simple citation rank.

In a rank citation method that is based on function 2, a document rank increases as the number of backlinks increases. However, unlike backlinks in the simple citation ranking method, different backlinks may have different weights. A backlink from a higher ranked document has more weight on the rank of the valuated document than does a backlink from a lower ranked document. Moreover, the higher the number of forward links in the backlinking document, the less weight it gives to each backlinked document.

By using such a citation ranking method, the score, which is given to each document, is based on the prevalence, the importance, and the accessibility of citations that are related to the ranked document. The prevalence of the valuated document affects the rank thereof, as each backlinking document j contributes a certain nonnegative value

$${α}^{\frac{{X}_{j}}{{n}_{j}} + \frac{( 1 - α ) {X}_{j}}{N}}$$

that usually increases the sum that determines the rank. The importance of the valuated document affects the rank thereof, as the importance of each backlinking document j is expressed in the numerator Xj of the value

$${α}^{\frac{{X}_{j}}{{n}_{j}} + \frac{( 1 - α ) {X}_{j}}{N}} ,$$

which is added to the sum. The accessibility of the valuated document affects the rank thereof, as each forward link that is found in the related document j is added the denominator nj of the value

$${α}^{\frac{{X}_{j}}{{n}_{j}} + \frac{( 1 - α ) {X}_{j}}{N}} .$$

The ranks form a probability distribution over a group of documents, so that the sum of ranks over all documents is unity. The rank of a document can be regarded as the probability that a surfing user will access the ranked document after following a large number of forward links. The constant α in the formula is regarded as the probability that the surfing user will randomly view an unlinked document instead of following a forward link. The rank for each of the documents can be calculated using a simple algorithm, and corresponds to the principal eigenvector of the normalized link matrix of the Web.

Such a citation ranking method may be used to rank billions of documents on the Web. As it is not possible to find the rank of each document by a simple calculation of a set of equations, an iterative procedure is usually used. U.S. Pat. No. 6,285,999, assigned to The Board of Trustees of the Leland Stanford Junior University, herein incorporated in its entirety by reference, discloses such an iterative process.

As further explained in the examples below, the aforementioned rank citation method does not always yield desirable ranking of documents in a processed group of documents. The score of a particular document may not be consistent with the actual prevalence, importance, and accessibility of backlinks and citations that are related to that document. As described with reference to the background section, this inconsistency is known as a rank-sink problem.

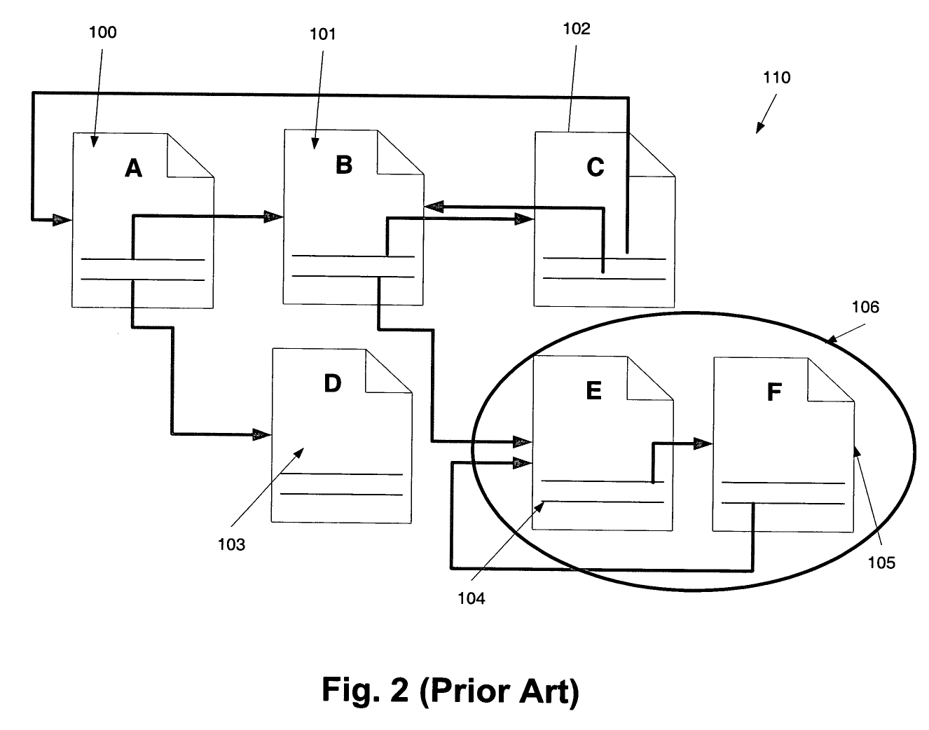

Reference is now made to FIG. 2, which is an exemplary diagram of six hyperlinked documents, numbered 100, 101, 102, 103, 104, and 105, which are used to illustrate the formation of a rank-sink. The rank-sink problem can further be described using graph terminology and FIG. 2. Each one of the documents 110 is defined as a node. If a subgroup of nodes does not have forward link, except between nodes of the subgroup, it forms a loop internal to the group that is defined as a terminal. For example, the combination of documents 104 and 105 forms a terminal 106. In hypermedia, a loop is a subgroup of documents that can be represented as strongly connected graphs in which, for every pair of nodes u and v, there is a path from u to v and a path from v to u.

Terminal 106 comprises subgroup 104 and 105 of documents that form a loop that results in increasing scoring, without causing the scoring of documents outside of the loop to be increased. As described above, such subgroups are known as rank-sinks. As explicitly exemplified below, the presence of such a rank-sink in a graph that represents a group of linked documents 110 can cause a ranking process, to produce undesirable outcomes. For example, in the depicted group of documents 110, the documents 104 and 105 of the terminal 106 will be ranked equally and all the others will get zero ranking. It should be noted that a ranking citation method, which is based on function 2 tries to avoid such a distortion by adding the α constant to the formula, as discussed above. Nevertheless, this modification does not solve the problem and the documents 104 and 105 will get high rank, much more then they deserve.

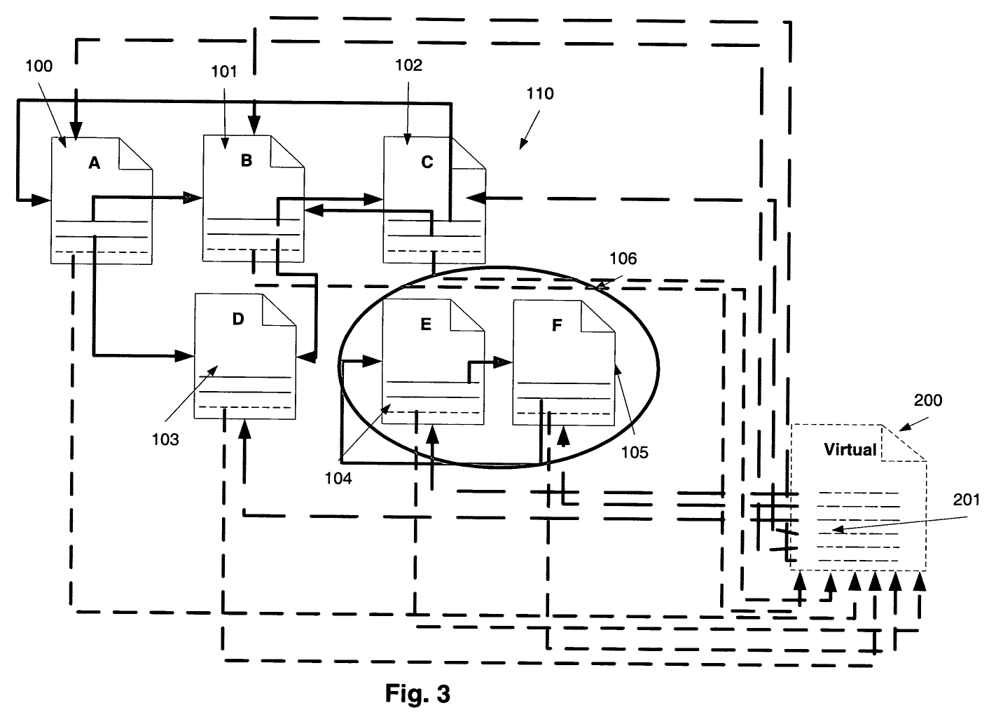

Reference is now made to FIG. 3, which is another exemplary diagram of hyperlinked documents. The figure illustrates how a virtual document 200 is used to prevent the rank-sink problem. The documents 110 and the links are as depicted in FIG. 2. However, the virtual document 200 and virtual links 201 are added to the linked documents, according to a preferred embodiment of the present invention.

In one embodiment of the present invention, a citation ranking method that integrates a rank-sink prevention mechanism is disclosed. As described above, the rank-sink problem occurs when a terminal 106 is formed in the graph that represents a group of linked documents 110. Thus, as long as a group of documents which is being analyzed can be represented as a graph without terminals, the rank-sink problem can be avoided. As commonly known, strongly connected graphs, do not have terminals. Therefore, the rank-sink problem may be avoided if, for every pair of documents u and v, there is a path of hyperlinks from document u to document v and a path of hyperlinks from document v to document u. The presence of such a bidirectional association between each pair of documents in the group is an indication of the absence of a rank-sink from the graph.

Thus, in one embodiment of the present invention, a virtual node represented by virtual document 200 is added to a graph that represents the group of documents 110. The virtual node comprises a list of virtual forward links 201 to all the documents in the group 110. Moreover, the virtual node 200 has a forward link thereto from all the other documents in the group 110. Adding a virtual node 200, as depicted in FIG. 3, assures that the group of documents 110 can be represented as a strongly connected graph. Even if one of the links connecting a pair of documents 110 in the group is removed, the added virtual links 201 and the virtual node 200 assures that a path from any document to any other document can be established. The graph that is formed by adding the virtual node, as described above, can be addressed as a strongly strongly connected graph.

Briefly stated, the present invention discloses a method in which the rank of a document Xi in a group that comprises N linked documents and an additional linked virtual document is defined as:

$${X}_{i} = {\sum }_{j ∈ {L}_{i}} \frac{{X}_{j}}{{n}_{j} + 1} \\ 1 \leq i \leq N + 1 \qquad Function 3$$

It should be noted that the rank citation method is implemented without adding a parameter that reflects a constant probability that is not based on the actual number of forward links, but on an arbitrary assumption regarding the probability that the surfing user randomly views any document instead of following a forward link. In function 3, as further described below, the probability that the surfing user randomly views any document instead of following a forward link is reflected from the number of related forward links. The contribution of these random views is represented by an additional forward link that links to the document from the added virtual node. Thus, in function 3 the probability that the surfing user randomly views any document instead of following a forward link is proportional to the reciprocal value of the number of forward links and therefore not constant. Therefore, ranking, which is based on a rank citation method according to function 3, is evaluated according to factual data and not according to hypothetical assumptions.

The citation ranking method that integrates a rank-sink prevention mechanism can also be presented using an (N+1)·(N+1) transition matrix A whose elements A[i][j] are given by:

$${A}_{[ i ] [ j ]} = \{ \begin{matrix}\frac{1}{{n}_{j} + 1} & j ∈ L i & i \neq N + 1 & j \neq N + 1 \\ 0 & j ∉ {L}_{i} & i \neq N + 1 & j \neq N + 1 \\ \frac{1}{{n}_{j} + 1} & & i = N + 1 & j \neq N + 1 \\ \frac{1}{N} & & i \neq N + 1 & j = N + 1 \\ 0 & & i = N + 1 & j = N + 1\end{matrix} \qquad Function 4$$

where ni is the total number of forward links from node i, and Li is a set of indices of documents linked to document i.

In one preferred embodiment of the present invention, it is possible to implement personalization. The idea of personalization is to bias the ranking in the ranking vector in a manner that better reflects the preferences of a certain user.

Such a bias can be added by giving different weights to the forward links from the virtual node.

Briefly stated, such an embodiment discloses a method in which the rank of a document Xi in a group that comprises N linked documents and an additional linked virtual document is defined as:

$${X}_{i} = {\sum }_{j ∈ {L}_{i} , j \neq N + 1} \frac{{X}_{j}}{{n}_{j + 1}} + {θ}_{i} {X}_{N + 1} , 1 \leq i \leq N \\ {X}_{N + 1} = {\sum }_{j = 1}^{N} \frac{{X}_{j}}{{n}_{j} + 1} \qquad Function 5$$

where θᵢ is the probability that the surfing user will browse document i.

The citation ranking method that integrates such a personalization mechanism can also be presented using an (N+1)·(N+1) transition matrix A whose elements A[i][j] are given by:

$${A}_{i , j} = \{ \begin{matrix}\frac{1}{{n}_{j} + 1} & j ∈ {L }_{i} & i \neq N + 1 & j \neq N + 1 \\ 0 & j ∉ {L}_{i} & i \neq N + 1 & j \neq N + 1 \\ \frac{1}{{n}_{j} + 1} & i = N + 1 & j \neq N + 1 & \\ {θ}_{i} & i \neq N + 1 & j = N + 1 & \\ 0 & i = N + 1 & j = N + 1 & \end{matrix} \qquad Function 6$$

where ni is the total number of forward links from node i, and Li is a set of indices of documents linked to document i.

It should be noted that many known methods for improving the ranking method may be integrated into the present invention. For example, rank can be increased for documents whose backlinks are maintained by certain institutions or authors or in various geographic locations. Preferably, the score is increased if links come from unusually important Web locations such as the home page of a main Website. Links can also be weighted by their relative importance within a document. For example, highly visible links that are near the beginning of a document can be given more weight. In addition, links that are in large fonts or are emphasized in other ways can be given more weight. In this way, the model can better approximate a document's usage and an author's intentions. In many cases, it is appropriate to assign a higher value to a link from a document that has been modified recently, as it comprises information that is less likely to be obsolete.

An important embodiment of the present invention is directed toward enhancing the quality and arranging the order of results from Web search engines. In this application of the present invention, a ranking method according to the present invention is integrated into a Web search engine to produce results which are not distorted by the formation of rank-sinks. A search engine employing a ranking method of the present invention provides automation while producing results comparable to a manually-maintained categorized system. In this approach, a Web crawler explores the Web and creates an index of the Web content, as well as a strongly connected graph of nodes corresponding to the structure of existing hyperlinks and the virtual hyperlinks to and from a virtual document. The nodes of the graph (i.e., the pages of the Web) are then ranked according to the prevalence, the importance, and the accessibility of citations that are related thereto, as described above in connection with various exemplary embodiments of the present invention.

The search engine is used to locate documents that match the specified search criteria, either by searching full text, or by searching titles only. In addition, the search can include the anchor text associated with backlinks to the document.

It should be noted that the present invention may be used for ranking any group of entities or articles that have links there among. For example, the disclosed ranking method may be used for ranking a market of buyers and sellers, members of a peer-to-peer network, members in an e-commerce environment, etc.

It should be noted that by using the virtual document for creating the aforementioned strongly connected graph, we enhance the stability of the ranking process. As the added virtual document creates an independent set of links that connects all the ranked documents in a bidirectional manner, minor changes to the interconnections between the ranked documents tend to have less effect on the ranking process. Thus, decreasing or increasing the number of forward links of a certain document, by one or two links, has less effect on the ranking of a document that is connected to a virtual document, as described above, than on a document that is not connected to a virtual document.

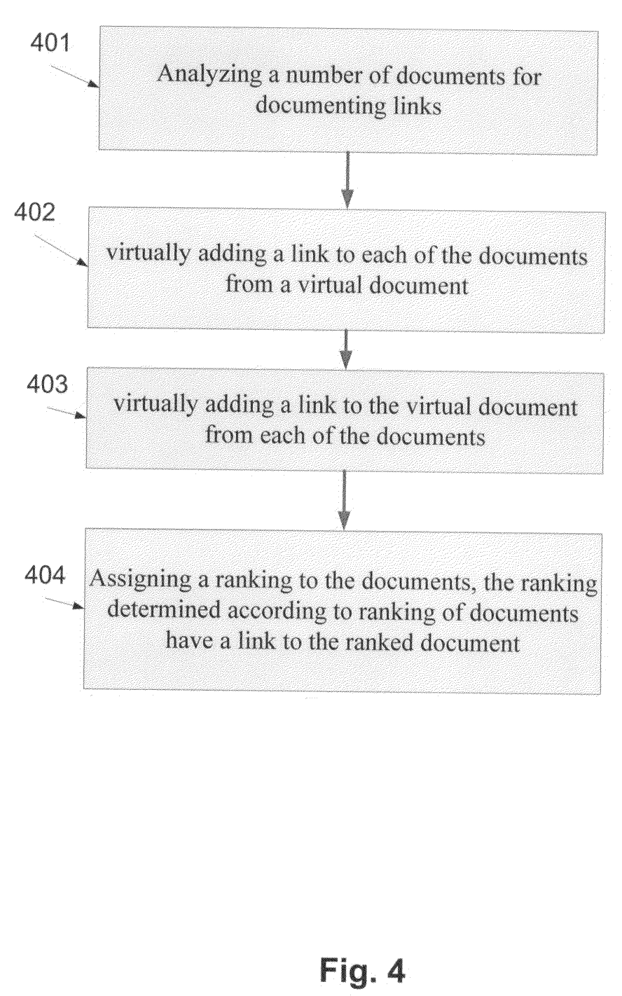

Reference is now made to FIG. 4, which is a flowchart of an exemplary method for determining the ranking for a number of linked documents, according to a preferred embodiment of the present invention. This method is configured with a rank-sink prevention mechanism that allows consistent ranking of the linked documents. The score of each document is determined based on the prevalence, the importance, and the accessibility of citations that are related to the ranked document. In the first step, as shown at 401, a number of linked documents is obtained. As described above, ranking linked documents using known citation ranking methods may yield undesirable rankings as the linked documents may create loops that forms rank-sinks. Therefore, in order to avoid rank-sinks, in the following step, as shown at 402, a link is created to each of the documents from a virtual document. A link is also created to the virtual document from each one of the documents, as shown at 403. As all the documents are linked to the virtual document and backlinked therefrom, no rank-sink can be formed, as described above. Then, as shown at 404, a score is assigned for all of the documents. The score for each document is determined according to the rankings of the documents which are linking thereto. Preferably, the rankings of the linked documents are determined according to the number of forward links and related backlinks or according to rankings of other linked documents, as described above. The description given in relation to functions 3 and 4 describes such a ranking process.

It is expected that during the life of this patent many relevant devices, methods and systems will be developed and the scope of the terms herein, particularly of the term search engine, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

In order to better illustrate how the present invention overcomes the rank-sink problem, a few illustrative, non-limiting examples are given below, in accordance with the present invention. In particular, the examples are intended to illustrate the differences between ranking a group of documents that form a graph with a rank-sink using a known ranking citation method and ranking the same group of documents using the ranking citation method of the present invention. It should be noted that these examples clarify that even if the known ranking citation methods address the rank sink problem by creating a strongly connected graph, their modification does not completely solve the rank sink problem. As exemplified below, the document that comprises the sink get higher ranking than they should have.

In one example, a group of linked documents that can be represented as a strongly connected graph is used. In particular, the example is implemented on a group of 20 hyperlinked documents, each one of the documents having an average of eight forward links and eight backlinks. Initially, a ranking citation method, which is based on function 2, is applied to the group. The value of the constant α is 0.85. The outcome of applying the method to the group's members is a ranking vector that is arranged as follows:

4 (1) 11 (2) 6 (3) 19 (4) 3 (5) 9 (6) 12 (7) 5 (8) 1 (9) 13 (10) 14 (11) 7 (12) 10 (13) 18 (14) 20 (15) 17 (16) 8 (17) 16 (18) 2 (19) 15 (20)

where, for each document, the number inside the brackets denotes the place of the document in the ranking and the number outside the brackets denotes an exemplary fixed label of the document.

Then, two additional documents, 21 and 22, are added to the group. As each one of the added documents comprises a forward link that points to the other added document, the additional documents form a hyperlinked loop. Document 22 comprises an additional forward link to the most important document 4 (1), while the document 21 is pointed to by the least important document 15 (20). This citation structure also forms a strongly connected graph. The outcome of applying the ranking citation method, which is based on function 2, on the expanded group is a ranking vector that is arranged as follows:

4 (1) 11 (2) 6 (3) 19 (4) 3 (5) 9 (6) 12 (7) 5 (8) 1 (9) 13 (10) 14 (11) 7 (12) 10 (13) 18 (14) 20 (15) 17 (16) 8 (17) 16 (18) 2 (19) 15 (20) 21 (21) 22 (22)

This outcome is clearly welcome, as the two added documents should be marked as the least important documents, having less related forward links than any other document in the expanded group. However, if the forward link that connects document 21 to document 4 is removed, an undesirable outcome is attained. Removing the forward link that connects document 21 to document 4 creates a rank-sink in the graph that represents the group of documents. After applying the ranking citation method, which is based on function 2, on the expanded group that forms the graph with the rank-sink, the outcome is a ranking vector that is arranged as follows:

4 (1) 11 (2) 6 (3) 19 (4) 3 (5) 21 (6) 22 (7) 9 (8) 12(9) 5 (10) 1 (11) 13 (12) 14 (13) 7 (14) 10 (15) 18 (16) 20 (17) 17 (18) 8 (19) 16 (20) 2 (21) 15 (22)

Such an outcome is clearly undesirable, as documents 21 and 22 are ranked higher than they should be. The ranking of documents 21 and 22 is not desirable as it is not consistent with the aforementioned prevalence, importance, and accessibility of citations that are related to these documents.

Reference is now made to the implementation of the ranking citation method of the present invention on the same group of 20 documents, which is discussed above. The applied ranking citation method is based on the aforementioned function 3. The outcome of applying the ranking citation method of the present invention on the group is a ranking vector that is arranged as follows:

4 (1) 11 (2) 6 (3) 3 (4) 19 (5) 9 (6) 12 (7) 5 (8) 1 (9) 13 (10) 14 (11) 7 (12) 18 (13) 20 (14) 10 (15) 17 (16) 8 (17) 16 (18) 2 (19) 15 (20)

Adding the additional documents 21 and 22 to the group does not change the order of the ranking of the document. As discuss above, each one of the added documents comprises a forward link to the other added document. Document 22 comprises a forward link to the most important document 4 (1), while document 21 is pointed to by the least important document 15 (20). The outcome of applying the ranking citation method of the present invention on the expanded group is a ranking vector that is arranged as follows:

4 (1) 11 (2) 6 (3) 3 (4) 19 (5) 9 (6) 12 (7) 5 (8) 1 (9) 13 (10) 14 (11) 7 (12) 18 (13) 20 (14) 10 (15) 17 (16) 8 (17) 16 (18) 2 (19) 15 (20) 21 (21) 22 (22)

The outcome is similar to the outcome of the execution of the ranking citation method that is based on function 2. However, when removing the forward link that connects document 21 to document 4, a different outcome results. Removing the forward link that connects document 21 to document 4 creates a rank-sink in the graph that represents the group of documents. After applying the ranking citation method on the expanded group that forms the graph with the rank-sink, the outcome is a ranking vector that is arranged as follows:

4 (1) 11 (2) 3 (3) 6 (4) 19 (5) 9 (6) 12 (7) 5 (8) 1 (9) 13 (10) 14 (11) 7 (12) 18 (13) 20 (14) 10 (15) 17 (16) 8 (17) 16 (18) 2 (19) 15 (20) 21 (21) 22 (22)

As documents 21 and 22 remain the least important documents, no substantial changes are foreseen after removing the link that connects document 21 to document 4. Unlike the ranking vector that is generated when applying the ranking citation method which is based on function 2, this ranking vector is consistent with the actual prevalence, importance, and accessibility of citations that are related to each one of the ranked documents.

Reference is now made to another example in which functions 2 and 3 are implemented on a larger database, the Sanford-web.dat database that simulates a real crawl of the Web. A copy of this database can be found at http://www.stanford.edu/sdkamvar. The size of the Sanford-web.dat matrix is n×n were n=281903.

The outcome of applying the ranking citation method that uses functions 2 and 3 on the Sanford-web.dat matrix is a ranking vector in which document number 89073 is ranked with the highest value, while document number 1 is ranked with the lowest value.

Two additional documents, 281904 and 281905 are added to the Sanford-web.dat database. As each one of the added documents comprises a forward link that points to the other added document, the additional documents form a hyperlinked loop. Document 281905 comprises an additional forward link to the most important document 89073 (1), while the document 281904 is pointed to by the least important document 1 (281903) of the original Sanford-web.dat database. This citation structure also forms a strongly connected graph. After applying the ranking citation method that is based on function 2 on the expanded matrix, documents 281904, 281905 are respectively ranked in places 95395 and 118858.

Removing the link from document 281904 to document 89073 results in documents 281904 and 281905 forming a rank-sink. As a result, the outcome of applying the ranking citation method that is based on function 2 is a ranking vector in which documents 281904 and 281905 are ranked among the top 10% of the documents, in places 27123 and 27953, respectively. Such a ranking change seems undesirable, as there is no logical explanation to this jump. For example, documents 82830 and 70023, which are ranked in places 27126 and 27143, respectively, have 30 and 54 backlinks, respectively, while document 281904 is in place 27123, although it has only two backlinks from non-important documents. This distortion is avoided when a ranking citation method that is based on function 3 is implemented on the Sanford-web.dat matrix.

The outcome of applying such a ranking citation method on the documents of the same matrix that is linked to the same two additional documents, 281904 and 281905, in a manner that forms a strongly connected graph, as described above, is a ranking vector in which the two additional documents are positioned in places 124514 and 165316. The outcome of removing one of the forward links of document 281904 in a manner that creates a rank-sink, as described above, and then applying the ranking citation method, is a ranking vector in which documents 281904 and 281905 are positioned in places 114049 and 121124, respectively. Unlike, the previous outcomes, where the ranking citation method that is based on function 3 is applied, no substantial changes in the position of documents 281904 and 281905 are foreseen.

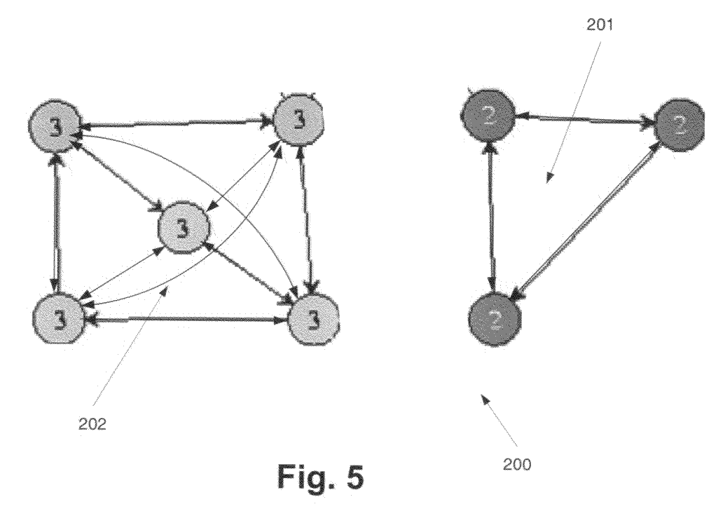

Reference is now made to FIG. 5, which is an exemplary graph of eight nodes 200, each node representing a hyperlinked document. The graph is used to demonstrate how applying a citation-ranking method, which is based on function 2, on two disconnected groups of hyperlinked documents, does not provide desirable ranking while applying a citation-ranking method, which is based on function 3, does provide desirable ranking.

The nodes of one subgroup, 201, are marked by the number 2. The nodes of another subgroup, 202, are marked by the number 3. In each of the subgroups 201 and 202, each one of the nodes has links to all the other members of the subgroup. As each node in each of the groups 201, 202 has a number of backlinks, which is related to the size of its group, it seems obvious that the ranking of nodes from a larger group has to be higher than the ranking of nodes from a smaller group. However, the outcome of applying a citation ranking method that is based on function 2 on the union of group 201 and group 202 is a ranking vector in which all the nodes of the union of the two groups receive the same rank.

The outcome of applying a citation ranking method that is based on function 2 on the union can clearly be seen if we take the following Lemma:

Let B1 and B2 be two sets of documents of sizes n1 and n2, respectively. Let every document in each set have links to all the other pages in its set. If C is the union of the two sets then the ranking vector of C is e=[1, . . . , 1]^{T}.

This Lemma can be proven as follows:

The (N)·(N) transition matrix A may be represented by:

$${A}_{ij} = \{ \begin{matrix}\frac{1}{{n}_{1} - 1} & 1 \leq i \leq {n}_{1} , 1 \leq j \leq {n}_{1} , i \neq j \\ \frac{1}{{n}_{2} - 1} & {n}_{1} + 1 \leq i \leq N , {n}_{1} + 1 \leq j \leq N , i \neq j \\ 0 & else\end{matrix}$$

When applying the matrix A and the vector e, it is easily verified that:

Ae=e

Consequently, when the ranking citation method that is based on function 2 is applied we receive:

$$\overline{A} e = α A e + ( 1 - α ) \frac{1}{n} e {e}^{T} e = α e + ( 1 - α ) e = e .$$

Therefore, it is clear that all the values of the nodes that comprise C are equal.

On the contrary, the outcome of applying a citation ranking method that is based on function 3 on the same union is a ranking vector in which the larger the node's group, the higher is the ranking of a page in the group. It should be noted that, when such a citation ranking method is applied, if none of the nodes comprises a forward link to a node external to its group, the relationship between the ranking of the node from one group and the ranking of a node from another group is related to the relationship between the sizes of the related groups.

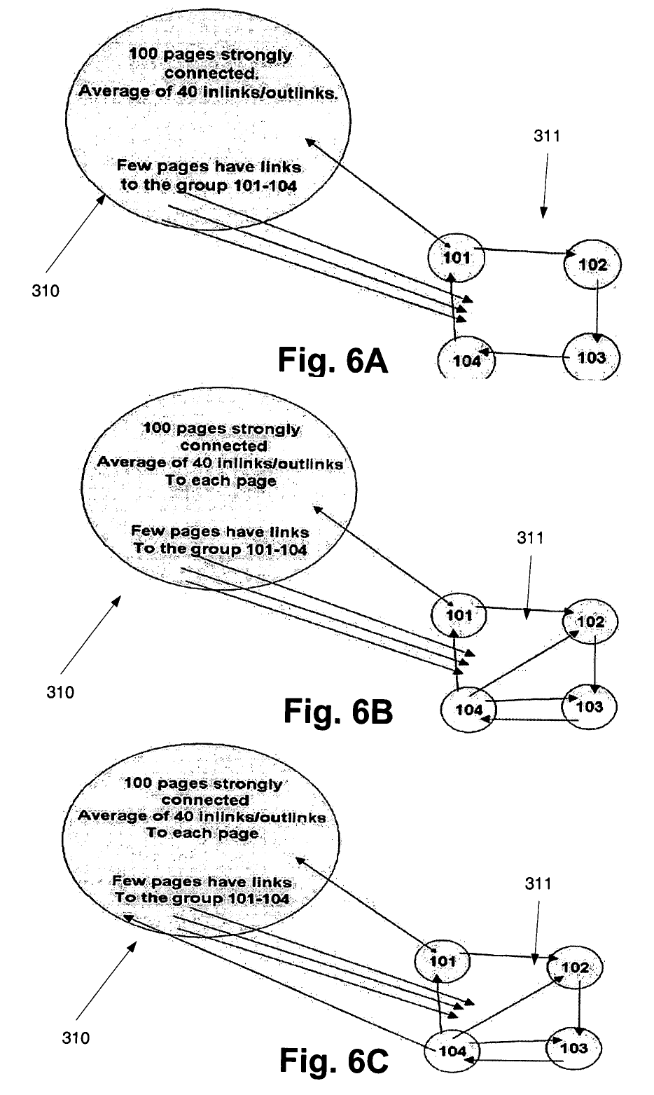

Reference is now made to FIG. 6A, 6B, and FIG. 6C which are exemplary graphs of two groups of nodes 310 311, each node representing a hyperlinked document. The backlinks and forward links among the nodes of group 311 are depicted in the FIG. 6A, 6B, and FIG. 6C. The average number of backlinks and forward links of each one of the nodes in group 311 is 40.

The graphs depicted in FIGS. 6A, 6B, and 6C are used to demonstrate instability of the ranking process even in cases where the graph is strongly connected. The instability is shown by ranking vectors, which are outputted when the ranking citation method that is based on function 2 is applied on graphs A, B and C. The vectors are significantly different from each other, though the way in which the links are deployed in each one of the graphs is only slightly different from the other graphs.

A ranking citation method, which is based on function 2, is applied to the two groups of nodes 310, 311 which are depicted in FIG. 6A. The value of the constant α is 0.85. The outcome of applying the method to the groups' members is a ranking vector in which documents are ranked in a manner that reflects the prevalence, the importance, and the accessibility of citations that are related to it. For example, nodes with many forward links in group 310 are ranked higher than nodes in group 311 that have much fewer forward links, such as node 104.

Then, the ranking citation method, which is based on function 2, is applied to the two groups of nodes 310, 311 which are depicted in FIG. 6B. As depicted in FIG. 6B, node 104 now further comprises an additional forward link and an additional backlink. Adding these links significantly changes the results of the ranking vector as node 104 becomes the most important node in the ranking vector. Clearly, this ranking vector does not reflect a desirable ranking of the nodes, as node 104 has only one backlink while other nodes in group 310 have an average of 40 backlinks.

The instability of the ranking citation method based on function 2, can further be exemplified by FIG. 6C. The outcome of applying the ranking citation method based on function 2, to the two groups of nodes 310, 311 which are depicted in FIG. 6C is a ranking vector in which node 104 is ranked in a low position.

Even though the graph depicted in FIG. 6C is strongly connected, group 311 is very close to being a rank sink. Removing only the forward link from group 311 to group 310 can form a sink of group 311. This closeness can be assumed as the factor that causes the instability. This instability can be solved, as discussed above, by combining the groups into a strongly connected graph.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of determining rankings among a plurality of documents, comprising:
a) analyzing said plurality of documents for documenting links to and from each of said plurality of documents;
b) virtually adding a link to each of said plurality of documents from a virtual document;
c) virtually adding a link to said virtual document from each of said plurality of documents; and
d) assigning rankings to each of said plurality of documents based on said links and said virtual links.

2. The method of claim 1, wherein a subtraction of one link from one of said plurality of documents does not substantially change said ranking.

3. The method of claim 1, wherein an addition of one link to one of said plurality of documents does not substantially change said ranking.

4. The method of claim 1, wherein said adding of stage b) comprises adding weights to respective links to each of said plurality of documents from said virtual document, said assigning rankings of stage d) to each of said plurality of documents being based on said weights.

5. The method of claim 4, wherein each said weight is based on the probability that a surfing user will browse a respective document of said plurality of documents.

6. The method of claim 1, wherein said assigning comprises:
scoring each of said plurality of documents based on said links and said virtual links; and
using said scores for ranking said plurality of documents.

7. The method of claim 6, wherein said scoring a certain document is determined according to scores of at least one document of said plurality of documents linking to said certain document and of said virtual document.

8. The method of claim 1, wherein said ranking is determined according to a uniform resource locator (URL), a host, a domain, an author, an institution, or a last update time of said at least one linked document.

9. The method of claim 1, wherein for each of said plurality of documents said ranking is determined according importance, visibility or textual emphasis of the documents linking to it.

10. The method of claim 1, wherein said plurality of documents belonging to a group consisting of: the Web, the Ethernet, a wired or wireless computer network, and a local area network.

11. The method of claim 1, wherein each one of said plurality of documents is a member of a group consisting of: Web pages, files, WORD documents, PDF documents, XML pages, HTML pages, and Internet page.

12. The method of claim 1, said assigning further comprising:
identifying a weighting factor for each of said at least one linking document; and
adjusting said ranking based on said weighting factor.

13. The method of claim 12, said weighting factor being dependent on the number of said plurality of documents.

14. The method of claim 1, wherein each one of said plurality of documents represents a member of a group of linked entities.

15. The method of claim 14, wherein said group of linked entities is a member of a group consisting of: a market of buyers and sellers, a group of peer-to-peer network users, and a group of e-commerce environment members.

16. A device for managing rankings for a plurality of linked documents, said device comprising:
a mapping module, configured for mapping a plurality of documents, at least some of said plurality of documents being linked documents, the mapping module being further configured to link a virtual document to and from each of said plurality of documents; and
a scoring module for assigning a ranking for at least one of said plurality of documents, said ranking being dependent on rankings of at least one of said linked documents including said virtual document.

17. The device of claim 16, wherein each one of said rankings is determined according to links to related documents of said at least one of said linking documents.

18. The device of claim 16, wherein each one of said rankings is determined according to links from related documents of said at least one of said linking documents.

19. The device of claim 16, wherein said ranking is determined according to a uniform resource locator (URL), a host, a domain, an author, an institution, or a last update time of said at least one linking document.

20. The device of claim 16, wherein said ranking is determined according to importance, visibility or textual emphasis of the links in said at least one linking document.

21. The device of claim 16, wherein said plurality of documents comprises a member of a group consisting of: the Web, the Ethernet, a wired or wireless computer network, and a local area network.

22. The device of claim 16, wherein each one of said plurality of documents is a member of a group consisting of: a Web page, a file, a WORD document, a PDF document, an XML page, an HTML page, and an Internet page.

23. The device of claim 16, said assigning further comprising:
identifying a weighting factor for each of said at least one linking document; and
adjusting said ranking based on said weighting factor.

24. The device of claim 23, said weighting factor being dependent on the number of said plurality of documents.

25. A method of ranking documents networked together by links, the method comprising:
adding a virtual document to said documents networked together,
adding to each document a virtual link to and from said virtual document, thereby converting said networked links into a strongly connected graph,
iteratively providing scores to each of said documents according to a number of links thereto and scores assigned to other documents linked thereto, said number of links including said virtual links, and
ranking said documents according to said scores.

26. A search engine for searching networked documents in a database, the search engine comprising:
a ranking module configured for mapping said networked documents, at least some of said networked documents being linked documents, said ranking module configured to link a virtual document to and from each of said networked documents, said ranking module configured for assigning a ranking for at least one of said networked documents, said ranking being dependent on rankings of at least one of said linked documents including said virtual document; and
a searching module configured for searching through said networked documents for hits according to a received query, said searching module being configured for retrieving hits and ordering said hits according to said ranking.
